(19) United States
(12) Patent Application Publication
(10) Pub. No.: US 2018/0093203 A1
(43) Pub. Date: Apr. 5, 2018

(54) CHOKE VALVE SEPARATOR

(71) Applicant: Typhonix AS, Bryne (NO)

(72) Inventor: Trygve HUSVEG, Varhaug (NO)

(73) Assignee: Typhonix AS, Bryne (NO)

(21) Appl. No.: 15/567,683

(22) PCT Filed: May 13, 2016
(86) PCT No.: PCT/NO2016/050089

§ 371 Date: Oct. 19, 2017

(30) Foreign Application Priority Data
May 18, 2015 (NO) 20150608

(51) Int. Cl. B01D 17/02; B01D 19/00; F16K 47/12; F16K 11/04; E21B 43/34

(52) U.S. Cl. CPC B01D 17/0217; B01D 19/0057; B01D 17/0208; F16K 31/12; F16K 11/04; E21B 43/34; F16K 47/12

(57) ABSTRACT

Choke valve separator, distinctive in that it comprises: an inlet, an inlet flow control valve, a choke and fluid conditioner part coupled to receive fluid from the inlet, comprising elements with conduits for flow per se or with the elements as stacked, at least in a final section thereof in the direction of flow the conduits have spiral or helical shape providing spiral or helical outlet flow from said part, a separation part, coupled to receive the fluid from the choke and fluid conditioner part comprising a volume into which the received fluid due to spiral flow or helical flow or gravity separates and distributes into phase volumes, at least two outlets from the separation part, and a housing.

### FIELD OF THE INVENTION

The present invention relates to choking and separation of multiphase flows. More specifically, the invention relates to a process device combining flow control and separation of two-phase or multiphase flow from petroleum wells and other sources. The device is termed a choke valve separator.

### BACKGROUND OF THE INVENTION AND PRIOR ART

Petroleum production wells are choked for several reasons:

Firstly, to choke down the pressure to the operation pressure of downstream equipment.

Secondly, to avoid excessive production of sand or water.

Thirdly, to ensure correct flow, by choking down all wells to the lowest wellhead pressure of the wells connected to a common manifold.

Fourthly, to isolate or dampen flow phenomena such as slug flow.

The choking results in a loss of energy inherent in the well fluid.

Eventually, multiphase flow from petroleum wells will be separated into specific phases. The separation of phases from one or more wells downstream a choke valve requires comprehensive process equipment and time for processing, resulting in technical challenges and comprehensive cost with respect to investment, operation and maintenance.

A demand exists for a choke valve that mitigates downstream separation processes, reduces the requirements for downstream process equipment and processing steps, thereby simplifying the equipment, reducing cost and improving reliability.

### SUMMARY OF THE INVENTION

The invention meets the demand by providing a choke valve separator.

The choke valve separator is distinctive in that it comprises:
an inlet,
an inlet flow control valve,
a choke and fluid conditioner part coupled to receive fluid from the inlet, comprising elements with conduits for flow per se or with the elements as stacked, at least in a final section thereof in the direction of flow the conduits have spiral or helical shape providing spiral or helical outlet flow from said part,
a separation part, coupled to receive the fluid from the choke and fluid conditioner part, comprising a volume into which the received fluid due to spiral flow or helical flow or gravity separates and distributes into phase volumes,
at least two outlets from the separation part, and
a housing.

In the volume of the separation part, the received fluid separates and distributes into annular or vertical or layered phase volumes at normal operation, due to spiral flow or helical flow or gravity, typically with heavier phases coaxially outside and/or below lighter phases.

The phrase a separation part, coupled to receive the fluid from the choke and fluid conditioner part, means that preferably but not necessarily all of the fluid entering the choke and fluid conditioner part flows through the choke and fluid conditioner part and also enters the separation part. Embodiments where some of the fluid, typically gas, or sand, is separated out from the main fluid flow upstream of the separation part are possible.

The term spiral flow or helical flow means that the flow includes a significant tangential component, for creating a cyclonic type flow for separating the phases into lighter and heavier phases. The separation effect and the shape of the separated phases as distributed in the volume depends on the inlet pressure and flow rate or flow velocity. At convenient pressure and flow rate in the received flow of fluid, a pure cyclonic type separation can be achieved, the separated phases distributing as annular or sleeve like segments inside the separation part volume, with heavier phases coaxially outside lighter phases. At zero inlet flow, the phases separate and distribute as phase layers with heavier phases below lighter phases, since the separation part will function as a gravitational separator. A quite usual situation will be an intermediate situation, with a semi cyclonic separation and distribution of the phases. This means that the phases distribute or accumulate in volumes having mixed shape, typically shaped as curved disc shaped phase segments with heavier phases below lighter phases, which will be better understood by studying FIG. 3 illustrating semi cyclonic separation in the choke valve separator of the invention.

Preferably, but not necessarily, the choke and fluid conditioner part comprises a number of parallel conduits for flow having a spiral shape, conical spiral shape, helical shape, or combinations or intermediate shapes thereof, at least in a final or downstream section of said conduits. Only the final section or length of the choke and fluid conditioner part, in the direction of flow, must comprise a spiral or helical flow section, for fluid conditioning and further separation in the separation part by tangential inflow to the separation part, for cyclonic type separation. Spiral flow means flow as a real spiral, achieved with a spiral shaped conduit with one, three or many revolutions around a point or axis of rotation, while the flow conduit departs from said point or axis for each revolution. However, also flow conduits having less than one revolution is included in this context, even though not preferable due to limited effect for combined fluid conditioning and choking. Helical flow means flow as a helix, achieved with a flow conduit shaped as a helix.

The choke valve separator, or more precisely the choke and fluid conditioner part thereof, at least towards the outlet, preferably comprises a stack of discs or cone-like plates, the discs or cone-like plates as stacked or per se comprises in substance spiral shaped flow conduits.

The choke valve separator, or more precisely the choke and fluid conditioner part thereof, preferably comprises one or more of the following features, in any combination:
a stack of discs or cone-like plates with integrated spiral shaped conduits,
a stack of discs or cone-like plates having spiral shaped grooves on at least one side, wherein the spiral shaped conduits have been formed by stacking said discs or plates, and
a stack of discs or cone-like plates having a spiral shaped opening punched out or otherwise formed and discs or plates without a spiral shaped opening, wherein the spiral shaped conduits have been formed by alternatingly stacking discs or plates with and without spiral shaped opening.

Spiral shaped opening means spiral shaped perforation or hole, through the disc or cone-like plate. Discs or cone-like plates with integrated spiral shaped conduits are for example tightly spiraled pipes or tubes, shaped as discs or cone-like plates.

Most preferably, the inlet extends as a central channel, outside which central channel the choke and fluid conditioning part is arranged as a number of parallel spiral shaped conduits. The spiral shaped conduits are preferably arranged as a stack coaxial outside the central channel.

The separation part is preferably arranged coaxial outside the choke and fluid conditioning part.

The number of said conduits connected inline for flow from the inlet determines the extent of choking. The number of spiral-shaped conduits can be 1, 2, 5, 10, 20, 50, 100 or in principle any integer within practical limits. Preferably, the number of conduits is in the range 2-2000, typically 5-200.

Typically each conduit has length in the range 0.05-1500 m, 0,2-1000 m, preferably 0.2-200 m, or 0.2-100 m, 1-100 m or 1-25 m, or 0.2-50 m. Preferably, each conduit has length of at least 0.5 m, more preferably at least 0.1 m, even more preferably at least 0.2 m, even more preferable at least 0.5 m, most preferable at least 1 m, such as 5, 10 or 30 m

In some preferable embodiments, all conduits are identical, preferably packed or stacked closely together.

Preferably, the spiral-shaped conduits are packed closely together and arranged coaxially inside the separation part and coaxially outside the inlet. The conduits are preferably arranged on discs or cones stacked closely together. The discs or cones can be made of different materials, such as metal, polymer or ceramic material, per se or in combinations.

Preferably, the conduits are parallel coupled with respect to flow, alternatively some or all of the conduits are serial coupled. The conduits extend radially outwards from the inlet, orthogonal as spirals or inclined as conical spirals, for all or at least the last part of the conduits as seen in the direction of flow. Preferably, each spiral comprises at least one revolution, more preferably at least three revolutions about the point or axis of rotation.

The conduits preferably have a cross section shape that is circular, quadratic, rectangular or hexagonal, preferably arranged with closest packing wall to wall or with common sidewalls. Quadratic, rectangular or hexagonal cross section shape allows closest packing with common sidewalls. However, for well flows being very erosive, erosion allowance can be provided by having more material between the conduits.

In some preferable embodiments, the choke and fluid conditioning part are in agreement with the teaching of patent publication WO 2014/178723 A1, herein incorporated by reference.

Possible alternative embodiments of the choke and fluid conditioning part comprises existing disc stack valves, for example as teached in US 2003/0188787 A1, and the separation friendly pressure reduction devices of international patent application WO 2014/178723 A1 and variations thereof.

In a preferable embodiment, the choke valve separator comprises a spin element in the inlet, for improved flow from the inlet into said conduits.

An angle of flow from the inlet into the conduits of the choke and fluid conditioner part is acute, orthogonal or low, preferably low. Preferably, the inlet into spiral shaped conduits of the choke and fluid conditioner part has enhanced cross section area for flow, compared to downstream parts or the remaining parts of said conduits.

Preferably, the cross section for flow of the conduits are decreasing in the direction of flow to provide equal or gradually increasing centripetal acceleration to the flowing fluid as the fluid in the spiral conduit flows away from the axis of rotation, in order to maintain or enhance the fluid conditioner effect as the conduit spiral radius decreases downstream. The spiral shaped conduits can have increasing cross section area in the direction of flow, for example to handle gas expansion. The spiral shaped conduits can have decreasing cross-section area in the direction of flow, for example to enhance flow conditioning and downstream separation in the separator part. The conduits can have variable cross section. The conduits can have shape that in substance is spiral shaped or helix shaped.

Preferably, the control valve can control the area for flow through the choke and fluid conditioner part from 0 to 100%, stepwise/discrete or continuous. Stepwise or discrete means connecting or blocking one and one conduit. 100% area for flow means not blocking any of the flow conduits for flow; in practice all conduits are open for flow, maintaining 100% of the flow cross section area. With for example 100 parallel spiral shaped conduits in the choking and fluid conditioning part, adjusting the control valve to block the inlet to 1 conduit means 99% area for flow and 1% of flow area blocked, referring to cross section area, and correspondingly when further conduit inlets are blocked. The relation between area for flow and choking is not necessarily linear, and 100% area for flow may or may not involve choking of the flow through the inlet. Very long parallel conduits, such as 10, 30 or 50 m long conduits, will necessarily give some choking due to friction. Likewise, thin conduits, or the combination of thin and long conduits, will increase the choking due to friction.

100% area for flow through the conduits, with all conduits open for flow, is not the same as an upstream or downstream nominal area for flow. The maximum area for flow through all conduits can be smaller than, equal to or larger than said nominal area for flow, optionally preferably larger in order to combine conditioning with only limited choking, such as 105% or 110% of an upstream pipe nominal flow area.

The choke valve separator of the invention can be designed to function as a well barrier, or not. To function as a well barrier, the choke valve must withstand the maximum static pressure of the one or more connected wells.

The choke valve separator preferably comprises several outlets, at different radial distances from the inlet and at different elevations, the number of outlets equals or is larger than the number of phases. Preferably, the choke valve separator comprises at least one outlet for each phase volume, preferably more outlets arranged at different radial distances from the inlet and at different elevations. The number of outlets can be any integer from 2, such as 2, 3, 4, 5, 6 or 10, preferably a larger number than the number of phases. This, together with convenient control and instrumentation, will ensure delivery of relatively clean phases at any inlet flow phase composition, variation thereof and variation in inlet pressure, and at start up. Convenient instrumentation and control comprises for example phase transmitters in the separation part, at different distances from an axis of fluid rotation at top and bottom and at different elevations, and in inlet and fluid outlets, pressure transducers in the inlet and outlets, and remotely controllable valves in the outlets, coupled in real time to a controller.

Preferably, the outlet and/or inlet into spiral shaped conduits of the choke and fluid conditioner part has enhanced cross section area for flow, compared to the remaining parts of said conduits. Said outlets preferably converge at the outlets, the outlets are preferably separated by a sharp edge structure, eliminating or reducing any volumes with stagnant fluid downstream, hence reducing turbulence.

The choke valve separator of the invention is preferably arranged vertically standing, with a vertical axis of rotation for cyclonic type separation. However, the choke valve separator must not be vertically standing, particularly when the inlet pressure is many times higher than the effect of gravity on the phases inside the separation part.

The invention also provides use of the choke valve separator according to the invention, for choking and separating the flow from a single well, a group of wells having in substance identical wellhead pressure or other sources. The other sources can be in process industry, food industry or chemical industry. For example, difficult emulsions and foamed mixtures, as often found in refineries, can be separated by the choke valve separator of the invention.

The technical and economic effect of the invention is far beyond what is immediately foreseeable.

The choke valve separator of the invention mitigates downstream separation processes, reduces the requirements for downstream process equipment and processing steps, thereby simplifying the equipment, reducing cost and improving reliability. The total choking and separation process becomes simplified, in some situations downstream separation can be eliminated. A reduction in use of chemicals, reduction in weight, reduction in size and reduction in energy requirement and energy consumption are further advantages of the invention.

Recently, it has been speculations on whether or not choking at wellheads may have unfavorable effect with respect to downstream separation, since the choke valve also functions as a phase mixer. In addition, the comingling and mixing of different well streams and phases in a choke valve and in a manifold may cause emulsification, foaming, scaling or other effects causing severe problems for downstream processing.

As a part of the work leading to the present invention, the Applicant has demonstrated that eliminating or reducing the unfavorable effect of traditional choking will result in separation at a speed and to an extent so far not achievable, since said unfavorable effect no longer will follow the fluid through the full process train. More specifically, the choke valve separator of the invention avoids or limits creation of tight emulsions, foam, scale and mixtures of the well flow fluids, in contrast to prior art choke valves. In a traditional choke valve, the phases of a well flow will be mixed intimately, requiring minutes of downstream processing to be separated. In contrast, with the choke valve separator of the invention, the phases of a well flow will be separated in seconds, coming out from the choke valve separator as separate phases, through separate outlets. In addition, further separation or other processing will be possible to a level of improved quality, since unfavorable effects to the fluid will be limited or eliminated. The two intensely opposing processes choking and separation are combined in one unit with the choke valve separator of the invention.

A possible effect with respect to the single well or group of commingled wells connected to the choke valve separator is that said wells can be produced closer to optimal conditions, increasing the hydrocarbon recovery.

As connected to single wells or groups of comingling wells, particularly subsea but also topsides and onshore, the downstream process plant can be reduced or eliminated. For example, using the choke valve separator subsea, the outlets for liquid can be coupled to a gas tolerant multiphase pump and the outlet for gas can be coupled to a liquid tolerant compressor, thereby eliminating further processing subsea. For use topsides, the size and weight of downstream processing equipment can be reduced dramatically, at least the typical first stage separator can be eliminated.

Avoiding to choke down single wells to the lowest pressure in a group of wells increases production and recovery. With the choke valve separator of the invention, more wells and fields will be profitable to produce.

The choke valve separator of the invention can comprise any feature or step as here illustrated or described, in any operative combination, each such operative combination is an embodiment of the present invention.

### FIGURE

FIG. 1 illustrates a preferable embodiment of a choke valve separator of the invention.

FIG. 2 illustrates the choke valve separator of the invention of FIG. 1, in a mode before startup of normal operation,

FIG. 3 illustrates the choke valve separator of the invention in a mode of semi cyclonic operation,

FIGS. 4 and 5 illustrate a part of the technical effect of the invention,

FIGS. 6a, 6b, 6c and 6d illustrate details of preferable embodiments, wherein protrusions of stackable elements fit into small recessions or grooves of the adjacent face of matching stackable elements,

FIGS. 7a, 7b, 7c and 7d illustrate some possible field applications, and

FIG. 8 illustrates an embodiment of the choke valve separator of the invention.

### DETAILED DESCRIPTION

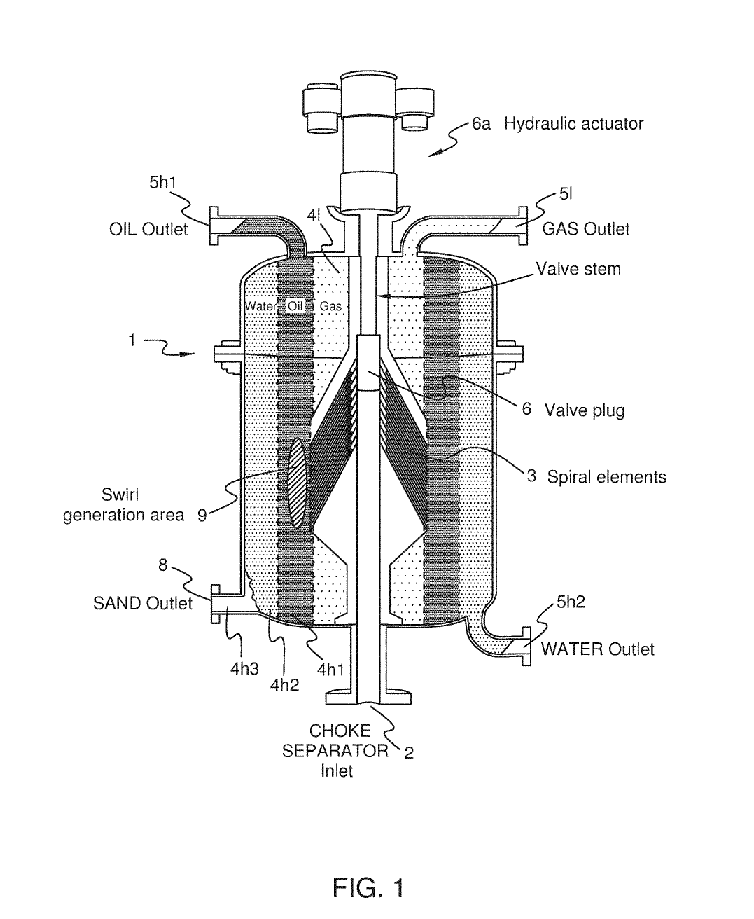

FIG. 1 illustrates a choke valve separator 1 of the invention. The choke valve separator 1 comprises: an inlet 2; a choke and fluid conditioner part 3 arranged coaxially outside the inlet and fluidly coupled to the inlet; a separation part 4 arranged coaxially outside the choke and fluid conditioner part and coupled to receive the fluid from the choke and fluid conditioner part as a conical spiral flow, having the main velocity component as a tangential velocity component. The separation part comprises: an annular phase volume 4l for a lighter phase and at least one further annular phase volumes 4h, 4h1, 4h2 . . . , for one or more heavier phases, with annular volumes for heavier phases coaxially outside annular volumes for lighter phases. The separation part contains an open volume into which the phases can separate and distribute into annular phase volumes during normal operation, the size of each volume depending on the phase composition. Further, the choke valve separator 1 comprises: an outlet 5l, 5h, 5h1, . . . , from each respective annular phase volume: an inlet flow control valve 6, a control valve actuator 6a, a housing 7 and a sand outlet 8. A volume with possible swirl generation 9 is also indicated.

In preferable embodiments, in order to eliminate or reduce possible problems caused by swirl generation, the conduits of the choke and fluid conditioning part converge at the outlets or a short distance upstream the separation part. The choke valve separator of the invention comprises one or more of the following features for this purpose, in any combination: conduit walls ending at downstream ends toward the conduit outlet as knife like edges, outlets from the conduits inside a common outlet pipe, conduits are combined into fewer and fewer conduits toward the outlet, ending as one larger cross section area conduit delivering the choked and fluid conditioned flow to the separation part. Most preferably, the conduits converge inside a shroud before the fluid flows into the separation part, neighbor conduit walls comprises sharp knife like ends where conduits converge, thereby eliminating or limiting stagnant volumes and flows of different velocities causing swirling.

The lighter phase is typically a gas phase or a lighter liquid phase. The heavier phase or phases are typically liquids, such as oil and water. The annular phase volumes are annular-shaped volumes where respective phases accumulate during cyclone-type separation. At start up or insufficient inlet pressure, gravitational separation can take place in the separation part, as the only or a significant separation mechanism.

In the illustrated embodiment, the angle for fluid flow from the inlet to the choke and fluid conditioner part is acute, but can be orthogonal or low. With an acute angle, the fluid velocity is preferably reduced by having increased cross section for flow into the conduits from the inlet.

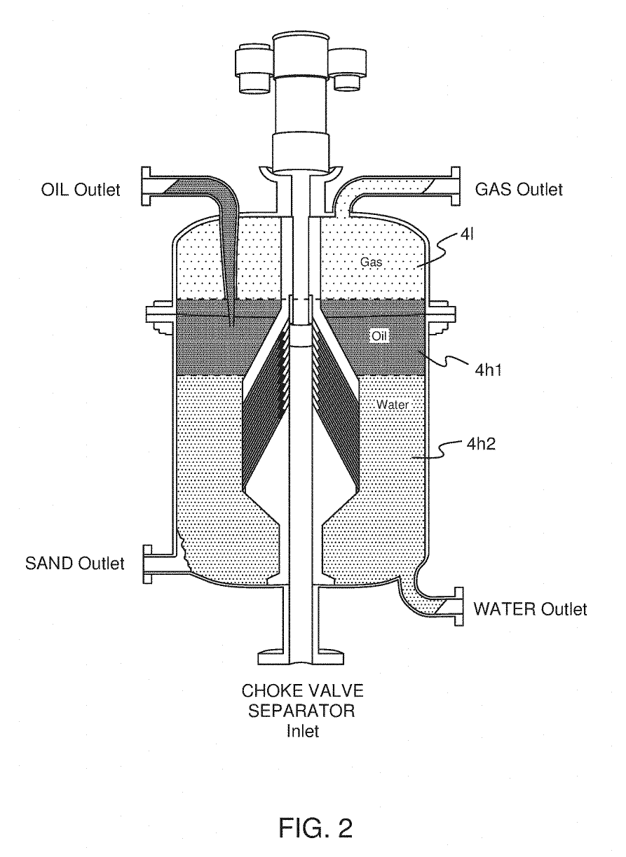

FIG. 2 illustrates the choke valve separator of the invention of FIG. 1, in a mode before startup of normal operation. As natural due to gravity, the phases have separated and been distributed into layers at different elevations, for a vertically standing choke valve separator. More specifically, gas, 41 has accumulated in the top of the choke valve separator; oil 4h1 in an intermediate part, and water 4h2 in a lower part of the illustrated vertically standing choke valve separator. During normal operation, the phase separate and distribute into annular volumes, the lighter phases inside heavier phases, as seen in FIG. 1. As mentioned, alternative embodiments of the choke valve separator comprises additional outlets (not illustrated) to ensure clean phases in the outlets at all time, also in the mixed separation type modes between start up and stable normal operation. For example, with the phases gas, oil and water, three outlets in the top and three outlets in the bottom, and three outlets in the sidewall at different elevation, can be convenient, referring to a vertical standing choke valve separator, meaning that the axis of rotation for cyclonic type separation is vertical. Outlets in the housing wall, and in top and bottom parts of the housing wall, the outlets not extending into the volume of the separation part, may improve the separation effect by not disturbing the cyclonic type flow and separation. Feasible instrumentation is commercially available from Roxar, Schlumberger and other suppliers. Feasible valves are commercially available from valve suppliers, for example Mokveld Valves. Preferably, the sensors and valves are operating in real time, automatically as controlled by algorithms or remotely controllable.

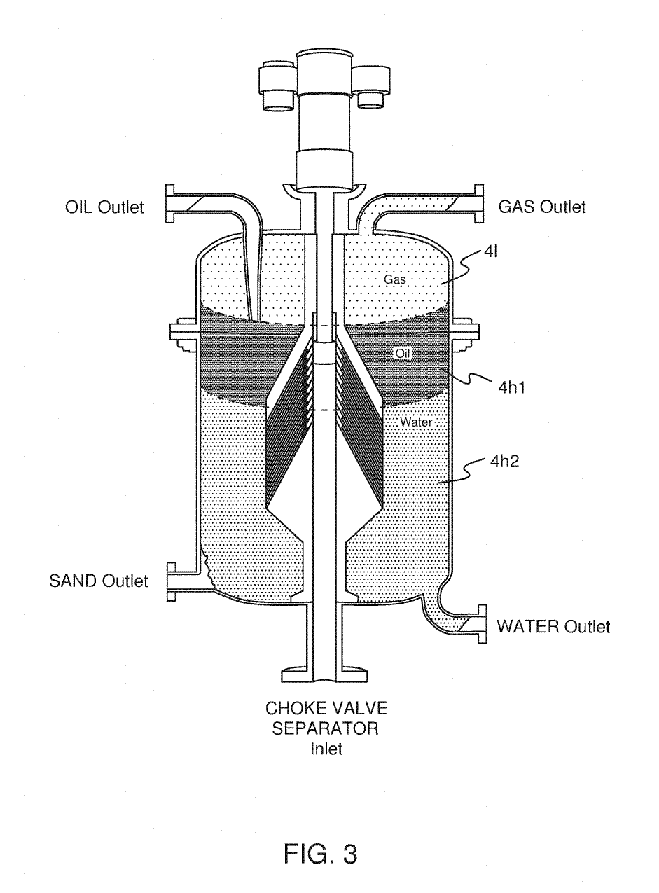

FIG. 3 illustrates the choke valve separator of the invention in a mode of semi cyclonic operation, which is a mixed type separation where both cyclonic separation and gravitational separation contribute. Due to the forces involved, the phases gas 4l, oil 4h1 and water 4h2 typically distribute into cup like or curved disc like or bowl like volumes, examples of which can be seen in FIG. 3. This can be seen easiest with the longitudinal section of the oil phase volume 4h1, having shape like a thick walled cup or disc. However, the top of the gas volume 4l is terminated by the top of the separation part volume and the bottom of the water phase volume 4h2 is terminated by the bottom of the separation part volume.

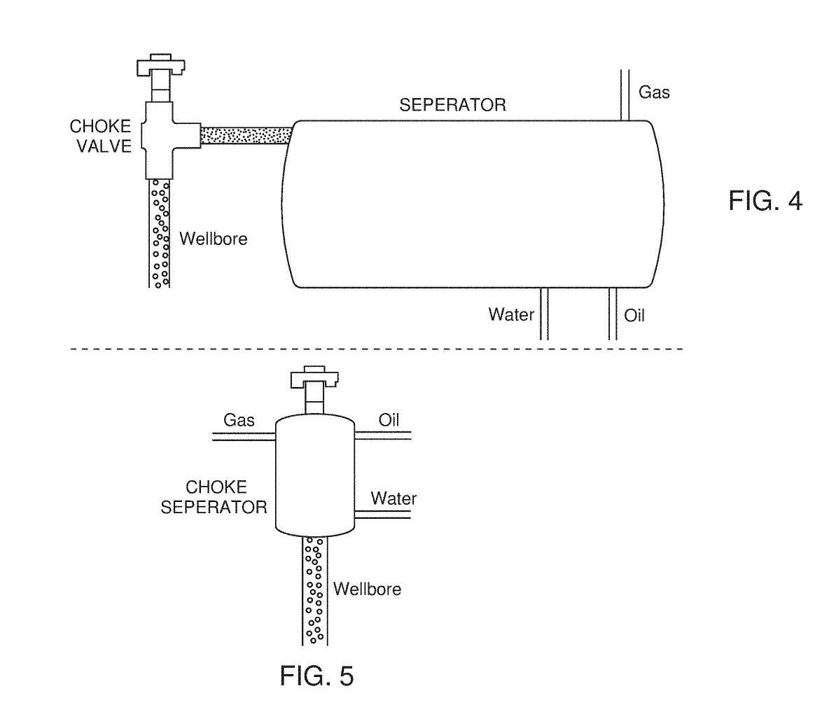

FIGS. 4 and 5 illustrate a part of the technical effect of the invention. FIG. 4 illustrates a traditional choke valve 10 as coupled to a separator 11. With the choke valve separator 1 of the invention, as illustrated in FIG. 5, the choke valve separator 1 receives the well stream from the wellbore 12 and deliver the phases through separate outlets, replacing the traditional choke valve and separator. Furthermore, the phases delivered from the choke valve separator have never undergone intense mixing as in a typical choke valve, resulting in phases more feasible for further separation.

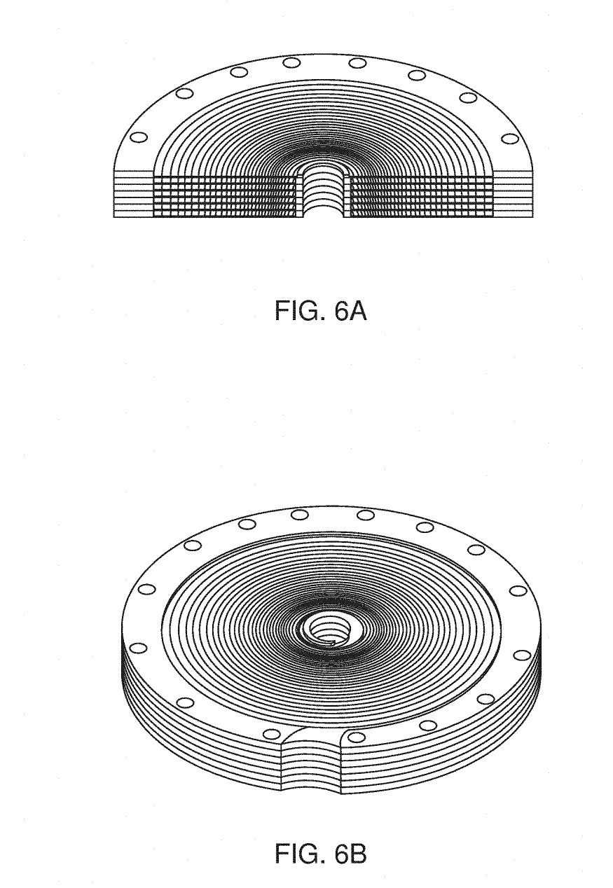

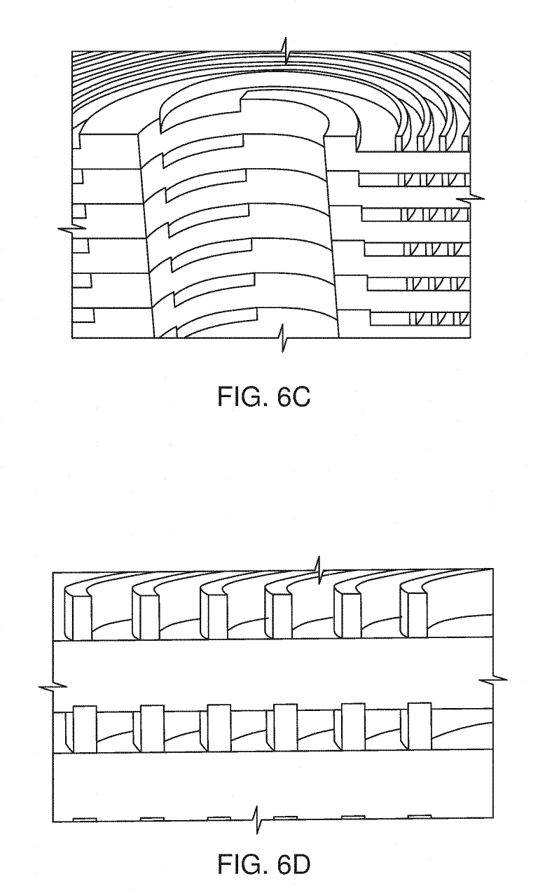

FIGS. 6a, 6b, 6c and 6d illustrate details of preferable embodiments, wherein protrusions of stackable elements fit into small recessions or grooves of the adjacent face of matching stackable elements. Such notch and groove-like features are feasible for all embodiments for which the choke and fluid conditioner part comprises stacked elements. Direct metal to metal sealing and elimination of or reduction of the number of any sealing elements between stackable elements can be achieved thereby.

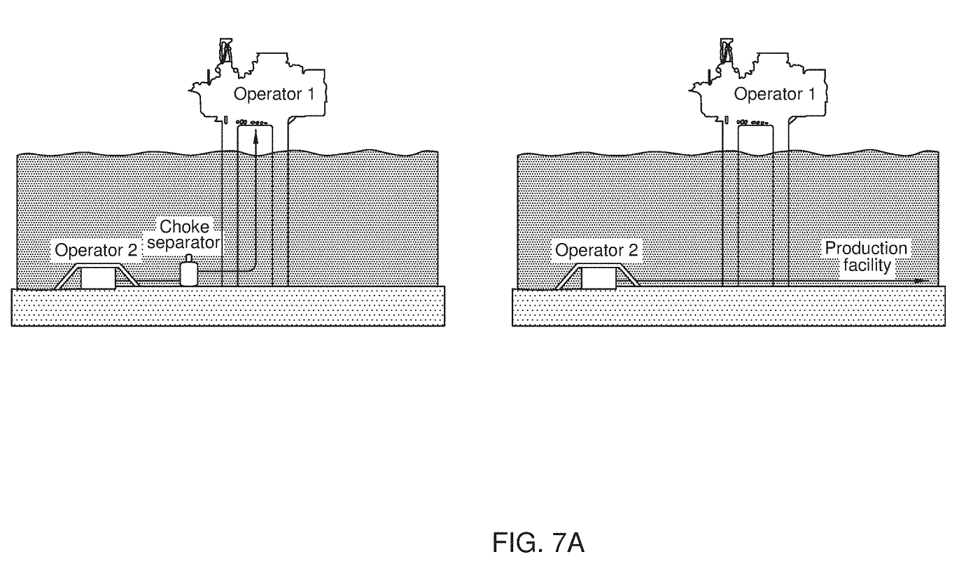

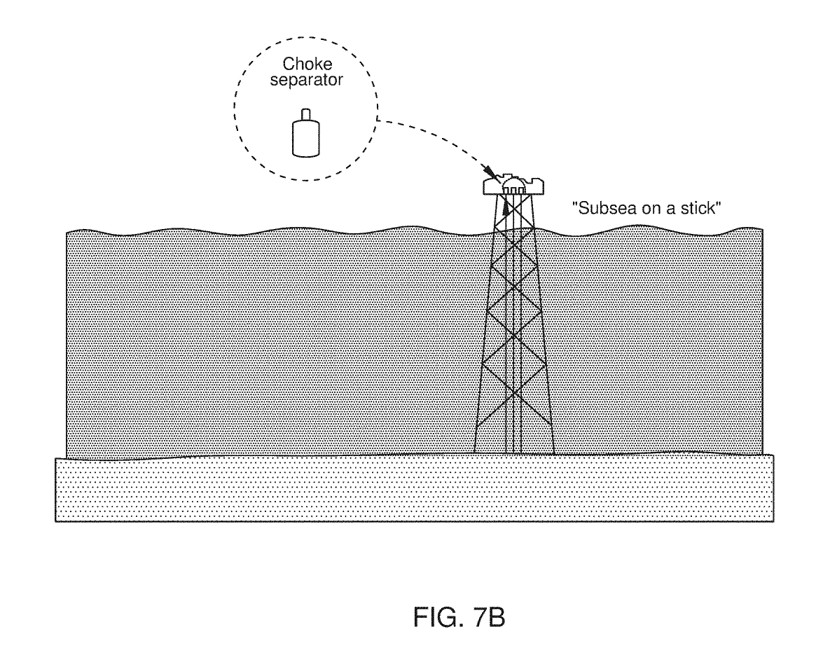

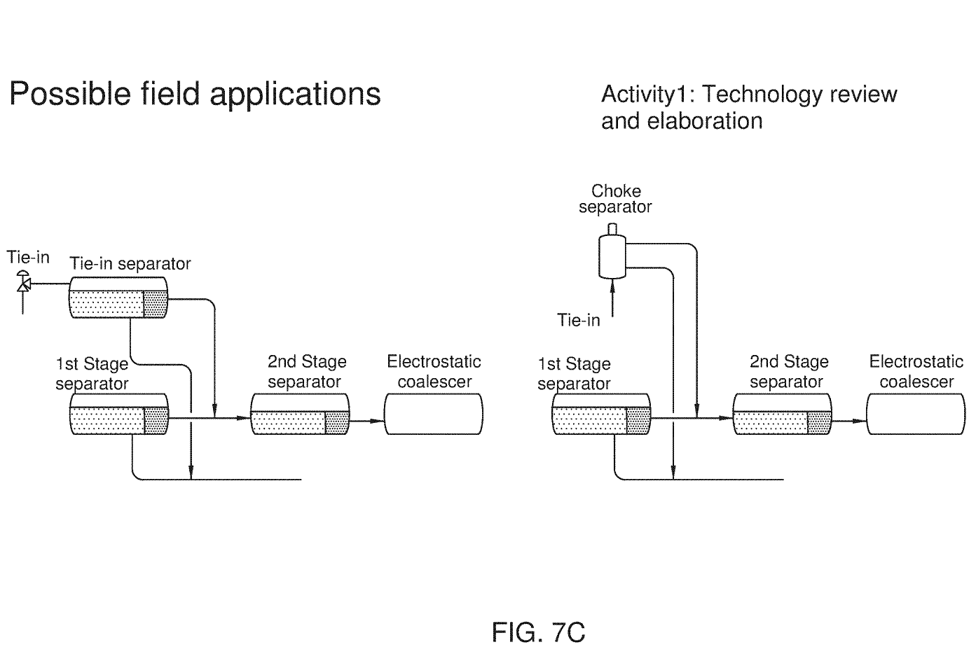

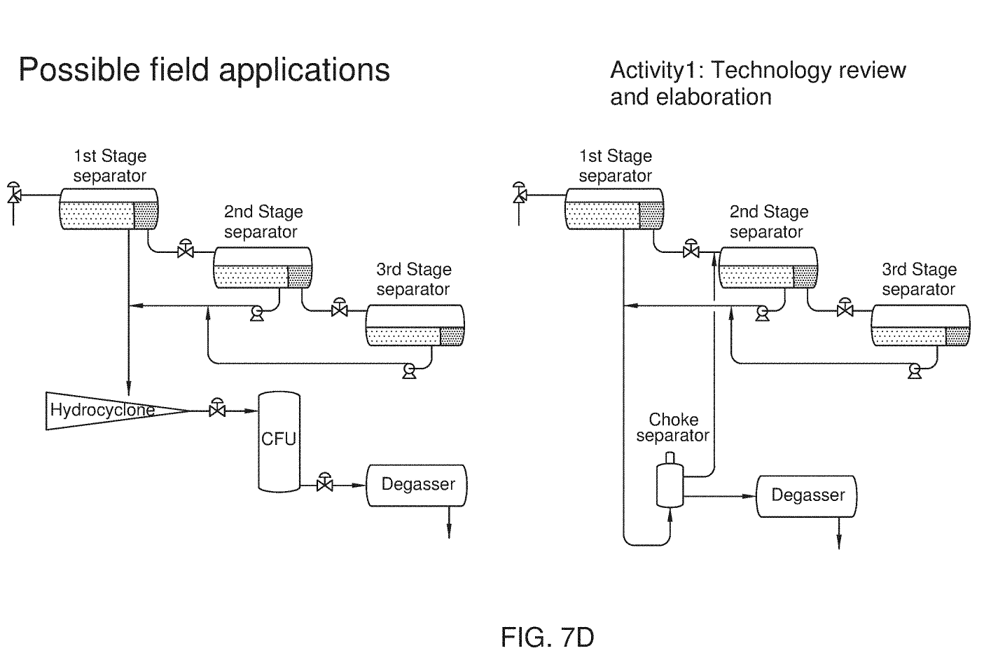

FIGS. 7a, 7b, 7c and 7d illustrate some possible field applications. More specifically, satellite field can be tied in to installations of another operator, as illustrated in FIG. 7a, since improved separation as provided by the invention allows measurement of petroleum fluid at improved accuracy. So-called subsea on a stick is feasible, with a choke valve separator on a typically unmanned platform, cf. FIG. 7b, in addition to possible choke valve separators arranged subsea. The choke valve separator of the invention may eliminate or replace other equipment, as seen by comparing the left side of FIGS. 7c and 7d with the right side of said figures, respectively.

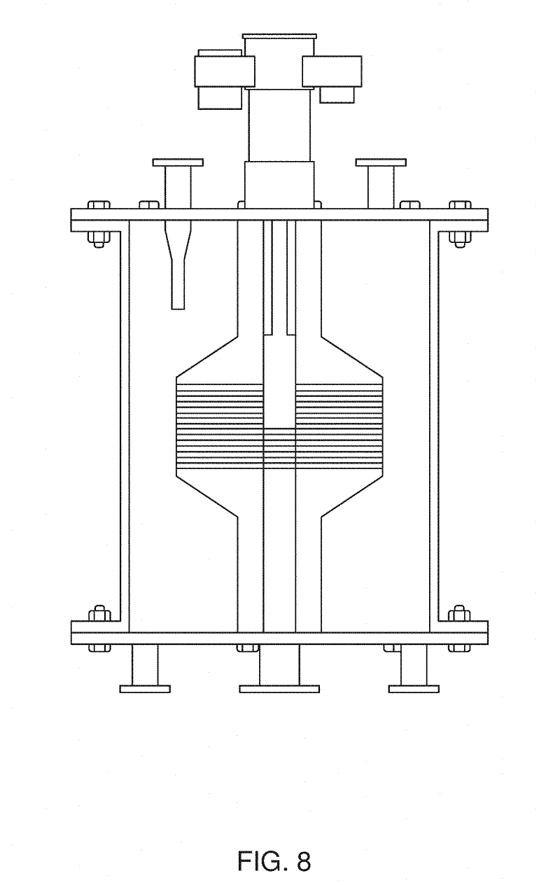

FIG. 8 illustrates an embodiment of the choke valve separator of the invention, comprising a pipe spool as housing. The effect is to simplify production and certification of the choke valve separator.

The choke valve separator of the invention is conveniently made using feasible structural steel as main construction material. However, other metals or alloys, ceramic material, composite materials and polymers, and combinations thereof, can be used, as found convenient using good engineering practice.

The choke valve separator of the invention can have many embodiments, particularly in how the inlet, the choke and fluid conditioner part and the control valve are designed. The choke and fluid conditioner part may for example comprise parallel flow conduits toward the inlet, coaxial to the inlet, with straight parallel conduits, with twisted or rotated conduits in an intermediate section, but having stacks of spiral shaped or conical spiral shaped conduits inside a separation part toward the outlet from the choke and fluid conditioner part. For embodiments with very long conduit lengths, for example, parallel conduits of 5, 10, 30 or 50 m, and for choke valve separators able to withstand open well pressure, such embodiments can be preferable to reduce pressure housing dimensions. The inlet valve can be a linear actuated valve blocking single conduits or groups of conduits stepwise or discrete. Another embodiment is to combine the spiral shaped part of the choke and fluid conditioner part with a cyclone, having the exit from the choke and fluid conditioner part in a position close to the axis of rotation, in contrast to a typical cyclone inlet, which has inlet tangential just inside the outer periphery in the upper end of the cyclone. A further embodiment comprises an exit from the choke and fluid conditioner part in a position tangential just inside the outer periphery in the upper part of a cyclone, which is one reason why in claim 1 it is not specified as obligatory that the choke and fluid conditioner part shall be arranged coaxially inside the separation part, contrary to what is preferable for most embodiments. The choke valve separator of the invention may comprise a conical bottom part or top or both conical bottom and top for embodiments with separation part designed like a cyclone.

1. A choke valve separator comprising:
an inlet;
an inlet flow control valve;
a choke and fluid conditioner part coupled to receive fluid from the inlet, comprising elements with conduits for flow per se or with the elements as stacked, at least in a final section thereof in the direction of flow the conduits have spiral or helical shape providing spiral or helical outlet flow from the part;
a separation part, coupled to receive the fluid from the choke and fluid conditioner part, comprising a volume into which the received fluid due to spiral flow or helical flow or gravity separates and distributes into phase volumes;
at least two outlets from the separation part; and
a housing.

2. The choke valve separator according to claim 1, wherein the choke and fluid conditioner part comprises several spiral-shaped conduits, each conduit having length of at least 0.05 m, more preferably at least 0.1 m, even more preferably at least 0.2 m, even more preferable at least 0.5 m, most preferable at least 1 m.

3. The choke valve separator according to claim 2, wherein the conduits have a cross section shape that is circular, quadratic, rectangular or hexagonal, arranged with closest packing wall to wall or with common sidewalls.

4. The choke valve separator according to claim 1, wherein the choke and fluid conditioner part comprises several spiral-like conduits, the conduits extend radially outwards from the inlet, orthogonal or inclined as conical spirals, preferably each spiral comprises at least one revolution, more preferably at least three revolutions.

5. The choke valve separator according to claim 1, comprising several outlets, at different radial distances from the inlet and at different elevations, the number of outlets equals or is larger than the number of phases, preferably at least one outlet for each phase volume.

6. The choke valve separator according to claim 1, wherein the outlet and inlet into spiral shaped conduits of the choke and fluid conditioner part has enhanced cross section area for flow, compared to the remaining parts of the conduits.

7. The choke valve separator according to claim 1, wherein the control valve can control the cross section area for flow from 0 to 100%, stepwise or continuous.

8. The choke valve separator according to claim 1, comprising phase transmitters in the separation part, at different distances from an axis of fluid rotation and at different elevations, and in inlet and fluid outlets, pressure transducers in the inlet and outlets, and remotely controllable valves in the outlets, coupled in real time to a controller.

9. The choke valve separator according to claim 1, comprising at least one of the following features, in any combination:
a stack of discs or cone-like plates with integrated spiral shaped conduits,
a stack of discs or cone-like plates having spiral shaped grooves on at least one side, wherein the spiral shaped conduits have been formed by stacking the discs or plates, and
a stack of discs or cone-like plates having a spiral shaped opening punched out or otherwise formed and discs or plates without a spiral shaped opening, wherein the spiral shaped conduits have been formed by alternatingly stacking discs or plates with and without spiral shaped opening.

10. (canceled)
